(19) United States
(12) Patent Application Publication
(10) Pub. No.: US 2026/0035220 A1
(43) Pub. Date: Feb. 5, 2026

(54) Trailer Tongue Jack Assembly with Manual and Torque Limited Power Drill Driver

(71) Applicant: Dutton-Lainson Company, Hastings, NE (US)

(72) Inventors: Collin S. Smyth, Kenesaw, NE (US); Zane A. Norton, Hastings, NE (US)

(21) Appl. No.: 18/790,299

(22) Filed: Jul. 31, 2024

(51) Int. Cl. B66F 3/10; B60D 1/46; B66F 3/20

(52) U.S. Cl. CPC B66F 3/10; B66F 3/20; B60D 1/465

(57) ABSTRACT

A jack assembly includes a telescoping body, a jackscrew adapted to extend and retract the telescoping body, and a drive train adapted to drive the jackscrew. The drive train includes (a) a first drive shaft adapted for connection to a handle, and (b) a second drive shaft adapted for connection to a power drill. The second drive shaft includes a torque limiter and a gear reduction section. The jack assembly is used in a related method of driving the jackscrew of a jack assembly.

### TECHNICAL FIELD

This document relates generally to jack assemblies and, more particularly, to a trailer tongue jack assembly allowing for both manual direct drive and torque limited power drill drive.

### BACKGROUND

Trailers for campers, boats and the like are equipped with tongue jacks that are adapted to support the tongue of the trailer when the trailer is disconnected from a towing vehicle. By adjusting the height of the tongue jack it is possible to raise and lower the tongue at the front end of the trailer thereby allowing one to level the trailer or even raise the trailer coupler into a position where it may later be conveniently lowered onto the hitch ball of a towing vehicle.

This document relates to a jack assembly that may be raised or lowered using either a manual crank handle or, in the alternative, a power drill. Cordless power drills are affordable and a large segment of the trailer using population already has access to one. Thus, the jack assembly advantageously allows for an operator to have the convenience of power jack drive without the costs associated with a jack having a built in drive motor or the headaches of having to find a power source for that motor.

The jack assembly is particularly useful on trailers, e.g., watercraft and boat trailers. When launching or recovering a boat, such trailers are often backed into the water far enough to at least partially submerge the jack assembly which could have a detrimental effect on a built-in motor drive. This problem is avoided when using a power drill to power the jack assembly disclosed herein.

### SUMMARY

In accordance with the purposes and benefits set forth herein, a jack assembly comprises, consists of or consists essentially of: (a) an outer tube; (b) an inner tube supported for telescopic movement within the outer tube; (c) a jackscrew operatively connected to the inner tube; (d) an input gear fixed to the jackscrew; and (e) a drive train adapted to drive the jackscrew through an output gear engaging the input gear, the drive train including a first drive shaft, a second drive shaft including a torque limiter, and a gear reduction section connecting the second drive shaft to the first drive shaft.

The first drive shaft may include a first input end adapted to receive a manual crank handle and the second drive shaft may include a second input end adapted to be engaged by a power drill. The output gear may be carried on the first drive shaft. The gear reduction section may include a compound gear carried on an intermediate shaft.

The jack assembly may further include a driven wheel carried on the first drive shaft and a driver carried on the second drive shaft. In such an embodiment, the gear reduction section may include a compound gear carried on an intermediate shaft. The compound gear may include a driven gear in engagement with the driver and a driver gear in engagement with the driven wheel.

In accordance with an additional aspect, the jack assembly comprises, consists of or consists essentially of: a telescoping body, a jackscrew adapted to extend and retract the telescoping body, and a drive train adapted to drive the jackscrew. The drive train may include (a) a first drive shaft adapted for connection to a manual crank handle and (b) a second drive shaft adapted for connection to a power drill. The second drive shaft includes a torque limiter such as a slip clutch.

In yet another aspect, the torque limiter and gear reduction section may be contained in a gear box housing supported by the telescoping body.

In still another aspect, the first and second drive shafts may extend through the gear box housing and the first drive shaft may further extend into the telescoping body wherein the output gear is carried on the first drive shaft.

The jack assembly may further include a gear reduction section between the first drive shaft and the second drive shaft. The gear reduction section may include a compound gear carried on an intermediate shaft.

In accordance with yet another aspect, a method of driving a jackscrew of a jack assembly is provided. The method comprises, consists of or consists essentially of providing the jack assembly with a first drive shaft adapted for directly driving the jackscrew with a manual crank and a second drive shaft adapted for driving the jackscrew through a torque limiter and gear reduction section with a power drill.

In another aspect of the method, the torque limiter and gear reduction section may be contained in a gear box housing supported by a telescoping body attached to the jackscrew.

In the following description, there are shown and described several different embodiments of the jack assembly and related methods of driving a jackscrew of a jack assembly. As it should be realized, the jack assembly and methods are capable of other, different embodiments and their several details are capable of modification in various, obvious aspects all without departing from the jack assembly and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the jack assembly and methods and together with the description serve to explain certain principles thereof. A person of ordinary skill in the art will readily recognize from the following discussion that alternative embodiments of the jack assembly and methods may be employed without departing from the principles described below.

FIG. 1 is a partially cut away and cross-sectioned view of the tongue jack assembly connected to a removable crank handle for manual operation by turning of the crank handle;

FIG. 2 is a detailed, exploded and perspective view of the drive train of the jack assembly, including the gear reduction section thereof;

FIG. 3 is a detailed, exploded and perspective view of the slip clutch and second drive shaft on which the slip clutch is carried; and

FIG. 4 is a view similar to FIG. 1 but illustrating operation of the jack assembly with a battery powered drill instead of the manual crank handle.

Reference will now be made in detail to the present embodiments of the jack assembly and related methods, examples of which are illustrated in the accompanying drawing figures, wherein like numerals are used to represent like elements.

### DETAILED DESCRIPTION

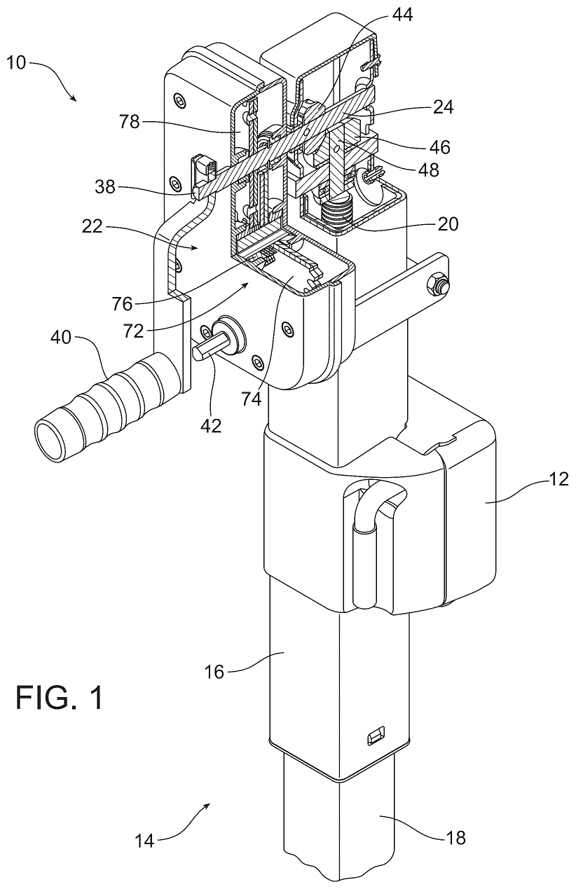

Reference is now made to FIG. 1 which illustrates the jack assembly 10 of the type that may be mounted by a mounting assembly 12 to a tongue of a camper trailer, boat trailer or the like (not shown). The jack assembly 10 includes a telescoping body generally designated by reference number 14. As is known in the art, the telescoping body 14 includes an outer tube 16 and an inner tube 18. The inner tube 18 is supported for telescoping movement within and relative to the outer tube 16. In the illustrated embodiment, the outer tube 16 and the inner tube 18 are made from hollow square steel tubing although other constructions are possible. As is known in the art, the inner tube 18 include a ground engaging foot or wheel (not shown) on the lowermost end thereof.

The jack assembly 10 also includes a jackscrew 20 that is operatively connected to the inner tube 18 by engaging a jack nut (not shown) fixed to the inner tube 18 in a manner known in the art. The jackscrew 20 is adapted to extend or retract the telescoping body 14; that is, extend the inner tube 18 downward from the outer tube 16 or retract the inner tube upward into the outer tube to respectively raise or lower the tongue of the trailer to which the jack assembly 10 is mounted. Further, the jack assembly 10 includes a drive train, generally designated by reference numeral 22, that is shown in FIGS. 1-3. The drive train 22 is adapted to drive the jackscrew 20 and control operation of the jack assembly 10.

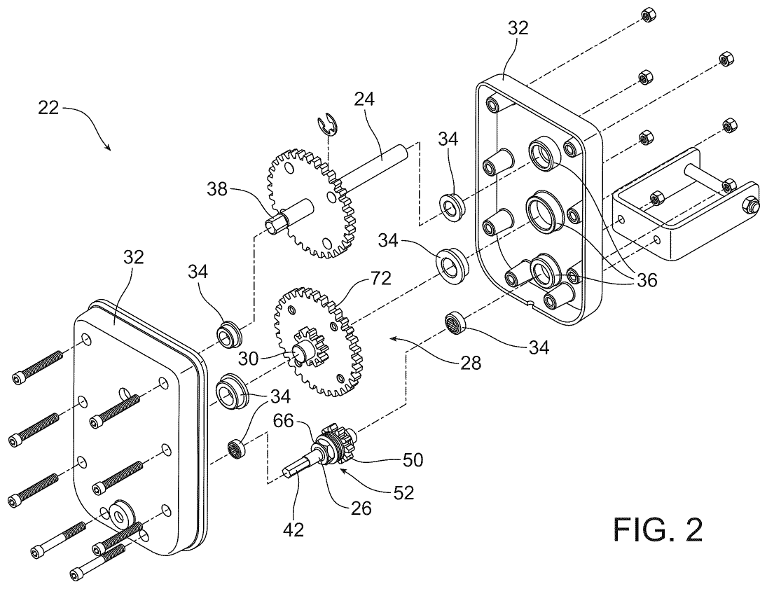

More particularly, as best illustrated in FIGS. 1 and 2, the drive train 22 includes a first drive shaft 24, a second drive shaft 26 and a gear reduction section generally designated by reference numeral 28. The first drive shaft 24, the second drive shaft 26 and the intermediate shaft 30 of the gear reduction section 28 are all supported for relative rotation by the gear box housing 32 in a manner known in the art. Note particularly the bearings 34 and the bearing receivers 36 built into or otherwise supported by the gear box housing 32, which gear box housing is supported by the telescoping body 14.

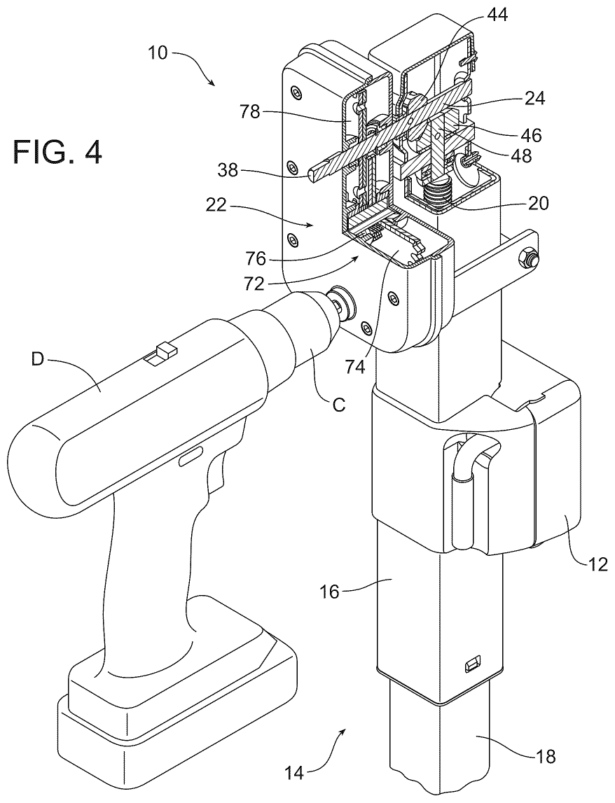

As shown in FIG. 1, the first drive shaft 24 includes a first input end 38 adapted to receive or engage hand crank 40, and extends through the gear box 32 and at least partially through the telescoping body 14. As illustrated, the hand crank 40 may be a removable, manual hand crank. The second drive shaft 26 includes a second input end 42 adapted to be engaged by a chuck C of a battery powered power drill D (see FIG. 4) and is otherwise contained within the gear box 32. An output gear 44 is carried on and fixed to the first drive shaft 24 a distance from the first input end 38 and within the telescoping body 14. The output gear 44 meshes with an input gear 46 fixed to an upper end 48 of the jackscrew 20 also within the telescoping body 14.

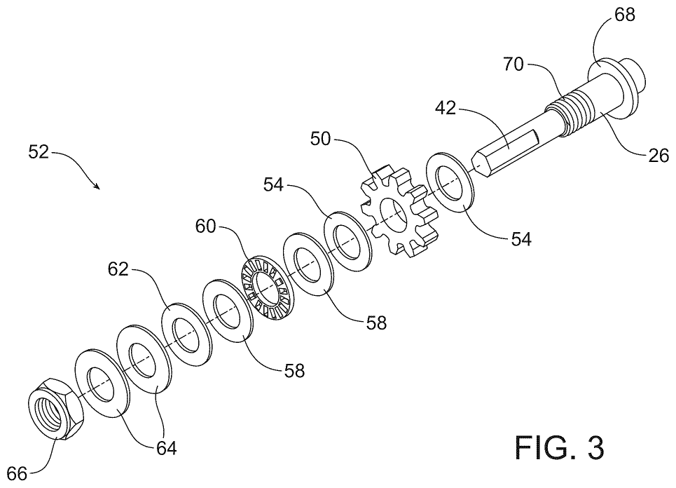

As best illustrated in FIGS. 2 and 3, the drive train 22 also includes a driver 50 and a torque limiter 52 between the second input end 42 of the second drive shaft 26 and the driver. As shown in detail in FIG. 3, the torque limiter 52 in the illustrated embodiment is a slip clutch. The torque limiter/slip clutch 52 includes two clutch pads 54 sandwiching the driver 50, and two thrust bearing races 58 sandwiching a thrust bearing 60. The described torque limiter/slip clutch 52 also includes a flat washer 62, two Belleville washers 64, and a lock nut 66. All of these components 54, 58, 60, 62, and 64 are positioned over the second input end 42 of the second drive shaft 26 in the order shown in FIG. 3 and tightened against a fixed stop 68 of the second drive shaft through engagement with and tightening of the lock nut 66 onto a threaded portion 70 of the second drive shaft. Of course, other variations of slip clutches may be utilized.

In the illustrated embodiment, the gear reduction section 28 includes a compound gear 72 carried on the intermediate shaft 30. The compound gear 72 includes a driven gear 74 in engagement with the driver 50, keyed or otherwise fixed to the second drive shaft 26, and a driver gear 76 in engagement with a driven wheel 78, keyed or otherwise fixed to the first drive shaft 24.

The trailer tongue jack assembly 10 is useful in a method of driving the jackscrew 20 with either (a) a manual crank handle 40 attached to the first input end 38 of the first drive shaft 24 as shown in FIG. 1, or (b) a power drill D attached to the second input end 42 of the second drive shaft 26 as shown in FIG. 4. When operating the jack assembly 10 using the power drill D, the torque limiter/slip clutch 52 on the second drive shaft 26 prevents the operator from being subjected to high torque forces created by the jackscrew 20 bottoming out, or if the jack assembly 10 is overloaded. The gear reduction provided by the gear reduction section 28 allows for proper operation of the torque limiter/slip clutch 52. The gear reduction also provides a more controlled speed when using a power drill D while reducing the amount of torque needed from the drill to operate the jack assembly 10. Thus, the capacity of the jack assembly 10 is not reduced when using the power drill D.

One of the issues with attaching a power drill D directly to a jack assembly without any gear reduction is having enough torque to operate the jack in a typical or customary manner. Otherwise, a rated capacity of the jack would have to be reduced. Advantageously, that is not the case with the disclosed jack assembly 10.

In contrast, when operating the jack assembly 10 manually, the removable manual crank handle 40 is connected to the first drive shaft 24 above the gear reduction section 28 so as to provide direct drive through the first drive shaft 24 and associated output gear 44 to the input gear 46 fixed to the jackscrew 20. Thus, the torque limiter/slip clutch 52 is bypassed when using the manual crank handle 40. As a result, the operating speed is the same as for a typical manual jack.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a washer”, as used herein, may also refer to, and encompass, a plurality of washers.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the jack assembly 10 and related methods disclosed herein have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A jack assembly, comprising:
an outer tube;
an inner tube supported for telescopic movement within the outer tube;
a jackscrew operatively connected to the inner tube;
an input gear fixed to the jackscrew; and
a drive train adapted to drive the jackscrew through an output gear engaging the input gear, the drive train including a first drive shaft, a second drive shaft including a torque limiter, and a gear reduction section connecting the second drive shaft to the first drive shaft.

2. The jack assembly of claim 1, wherein the first drive shaft includes a first input end adapted to engage a handle and the second drive shaft includes a second input end adapted to engage a power drill.

3. The jack assembly of claim 2, wherein the output gear is carried on the first drive shaft.

4. The jack assembly of claim 3, wherein the gear reduction section includes a compound gear carried on an intermediate shaft.

5. The jack assembly of claim 2, further including a driven wheel carried on the first drive shaft and a driver carried on the second drive shaft and wherein the gear reduction section includes a compound gear carried on an intermediate shaft.

6. The jack assembly of claim 5, wherein the compound gear includes a driven gear in engagement with the driver and a driver gear in engagement with the driven wheel.

7. The jack assembly of claim 6, wherein the torque limiter is a slip clutch.

8. The jack assembly of claim 1, wherein the torque limiter and gear reduction section are contained in a gear box housing supported by the telescoping body.

9. The jack assembly of claim 8, wherein the first and second drive shafts extend through the gear box housing and the first drive shaft further extends into the telescoping body wherein the output gear is carried on the first drive shaft.

10. A jack assembly, comprising:
a telescoping body;
a jackscrew adapted to extend and retract the telescoping body; and
a drive train adapted to drive the jackscrew, the drive train including (a) a first drive shaft adapted for engaging a handle and (b) a second drive shaft adapted for engaging a power drill, wherein the second drive shaft includes a torque limiter.

11. The jack assembly of claim 10, further including a gear reduction section between the first drive shaft and the second drive shaft.

12. The jack assembly of claim 11, wherein the gear reduction section includes a compound gear carried on an intermediate shaft.

13. The jack assembly of claim 12, wherein the torque limiter and gear reduction section are contained in a gear box housing supported by the telescoping body.

14. The jack assembly of claim 13, wherein the first and second drive shafts extend through the gear box housing and the first drive shaft further extends into the telescoping body wherein an output gear is carried on the first drive shaft to drive the jackscrew through engaging an input gear.

15. The jack assembly of claim 10, wherein the torque limiter is a slip clutch.

16. The jack assembly of claim 10, further including a compound gear carried on an intermediate shaft to provide gear reduction between the first and second drive shafts.

17. The jack assembly of claim 16, wherein the torque limiter, compound gear, and intermediate shaft are contained in a gear box housing supported by the telescoping body.

18. The jack assembly of claim 17, wherein the first and second drive shafts extend through the gear box housing and the first drive shaft further extends into the telescoping body for driving the jackscrew.

19. A method of driving a jackscrew of a jack assembly, comprising:
providing the jack assembly with a first drive shaft adapted for directly driving the jackscrew with a manual crank, and a second drive shaft adapted for driving the jackscrew through a torque limiter and gear reduction section with a power drill.

20. The method of driving a jackscrew of a jack assembly of claim 19, wherein the torque limiter and gear reduction section are contained in a gear box housing supported by a telescoping body attached to the jackscrew.
